(19) United States
(12) Patent Application Publication
(10) Pub. No.: US 2009/0273239 A1
(43) Pub. Date: Nov. 5, 2009

(54) SEMICONDUCTOR POWER DISTRIBUTION AND CONTROL SYSTEMS AND METHODS

(76) Inventors: Kenneth J. Goodnow, Essex Junction, VT (US); Stephen G. Shuma, Underhill, VT (US); Peter A. Twombly, Shelburne, VT (US)

Correspondence Address: CANTOR COLBURN LLP-IBM BURLINGTON, 20 Church Street, 22nd Floor, Hartford, CT, 06103, US

(21) Appl. No.: 12/113,999

(22) Filed: May 2, 2008

(51) Int. Cl. H02J 1/00

(52) U.S. Cl. 307/35

(57) ABSTRACT

A system for dynamic integrated circuit power distribution and control is disclosed. The system includes an external power consumption target generator configured to generate a power dissipation target for one or more integrated circuits. The system also includes a first integrated circuit that includes an IC power control unit coupled to the external power consumption target generator. The first integrated circuit also includes a first plurality of functional units, each functional unit of the first plurality including a unit power level control and a first power control grid coupling the IC power control unit to one or more of the first plurality of functional units. The IC power control unit is configured to generate a mode control signal which places at least one of plurality of functional units into a first mode of operation based upon the power consumption target.

### BACKGROUND OF THE INVENTION

The present invention is directed to power management and, in particular, to power management and distribution for integrated circuits.

As the electronics industry moves to new integrated circuit (IC) fabrication technologies, chip designers must deal with tighter power specifications and with new power constraints. In large and complex designs, implementing a reliable power network and minimizing power loss have become major challenges for design teams.

In particular, power dissipation has become one of the leading challenges in chip design and implementation. Dynamic power dissipation occurs in logic gates as they switch states. During switching, power supplies must charge internal capacitance associated with a gate's transistors. That process consumes power. The gate also must charge any external, or load, capacitances that comprise parasitic wire capacitances and input capacitances associated with downstream logic-gate inputs. Static power dissipation occurs in inactive, or static, logic gates. Even though one static gate does not consume much power, total power consumption becomes significant because ICs now contain tens of millions of gates.

In IC's constructed using present complementary metal oxide semiconductor (CMOS) fabrication processes (such as the so-called 65 nm, 45 nm, 32 nm processes), power consumption is no longer scaling as it has in the past because fundamental atomic limits are being reached. A lot of work has been focused on the solution to this problem. There are a number of innovative circuit and system designs to reduce power, or to trade off power consumption for performance. These solutions, however, may not allow for optimal power consumption based upon externally communicated system priorities and requirements.

### BRIEF SUMMARY OF THE INVENTION

An exemplary embodiment of the present invention is directed to a system for dynamic integrated circuit power distribution and control. The system of this embodiment includes an external power consumption target generator configured to generate a power dissipation target for one or more integrated circuits. The system of this embodiment also includes a first integrated circuit that includes an IC power control unit coupled to the external power consumption target generator, a first plurality of functional units, each functional unit of the first plurality including a unit power level control, and a first power control grid coupling the IC power control unit to one or more of the first plurality of functional units. The IC power control unit of this embodiment is configured to generate a mode control signal which places at least one of plurality of functional units into a first mode of operation based upon the power consumption target.

Another embodiment of the present invention is directed to an integrated circuit that includes an IC power control unit configured to receive a power consumption target value from an external power consumption target generator. The integrated circuit of this embodiment also includes a first plurality of functional units, each functional unit of the first plurality including a unit power level control and a first power control grid coupling the IC power control unit to one or more of the first plurality of functional units. The IC power control unit of this embodiment is configured to generate a mode control signal which places at least one of plurality of functional units into a first mode of operation based upon the power consumption target.

Another embodiment of the present invention is directed to a method for dynamically controlling power distribution of a power in system including multiple integrated circuits. The method of this embodiment includes receiving at a first integrated circuit a power consumption target from an power consumption target generator; creating a mode of operation for one or more functional units of the first integrated circuit based on the power consumption target; and transmitting the mode of operation to one or more of the functional units.

### BRIEF DESCRIPTION OF THE DRAWINGS

Referring now to the drawings wherein like elements are numbered alike in the several FIGURES:

FIG. 1 is a block diagram of a system according to an embodiment of the present invention;

FIG. 2 shows a more detailed block diagram of an integrated circuit according to an embodiment of the present invention;

FIG. 3 shows more detailed depiction of an example unit power level control;

FIG. 4 shows an example of a method according to one embodiment of the present invention; and

FIG. 5 shows a more detailed flow diagram of the process that may occur in step 404 of FIG. 4.

### DETAILED DESCRIPTION OF EXEMPLARY EMBODIMENTS

An exemplary embodiment of the present invention provides systems and methods for dynamic reconfiguration of semiconductor device activity to react to changing power allocation targets from an external source. The semiconductor device (or IC) continues to actively operate, however, operation may be adjusted to meet power allocation targets. These allocation targets may include power dissipation values and, in some embodiments, may be updated through time

In some embodiments, an external power control target generator sets a power consumption target for the IC. This power consumption target may be received by an IC power control unit. The IC power control unit may be located on-chip. In that case, the IC power control unit controls the power consumption for a particular chip. Of course, the IC power control unit could also be located off-chip. In other embodiments, the IC power control unit may be configured to control the power consumption of more than one chip.

A particular IC may include one or more functional units. These functional units could be, for example, embedded processors, connection logic, high or low speed input-output units or other types of interfaces or any other type of functional unit. As is well know in the art, each of these functional units may draw power from a power grid which may be implemented, for instance, as a power grid or power bus. In some embodiments, one or more of the functional units may also include a unit power control element. The unit power control element may be configured to receive a signal from the IC power control unit telling it how much power it may consume. The amount of power an individual functional unit may consume may be based on which of a plurality of modes the individual functional unit may operate in. The IC power control unit may maintain a listing of all of the modes for each multi-mode functional units it is responsible for and may, based on the power consumption for all of the individual multi-mode functional units (and other possibly fixed power consumption of the chip) determine in which mode each multi-mode functional unit should operate to meet the power consumption target for the IC.

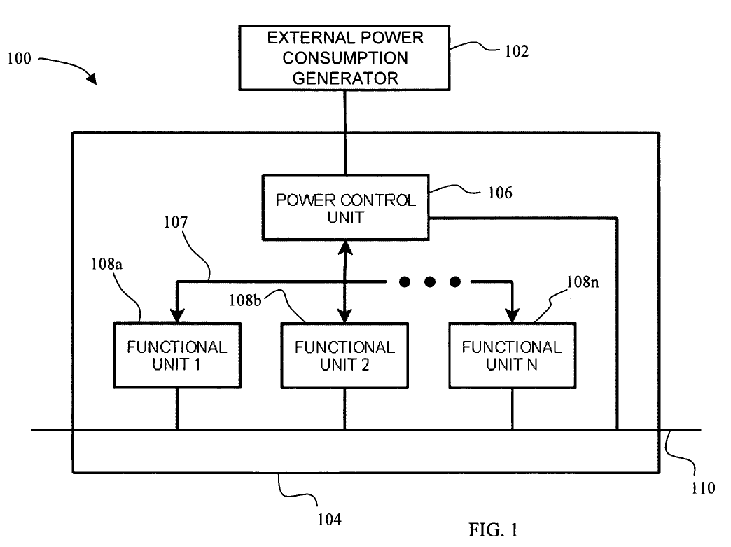

FIG. 1 is a block diagram of a system 100 according to an embodiment of the present invention. The system 100 may include an external power consumption target generator 102. The external power consumption target generator 102 generates a total power usage for the IC 104. In some embodiments, the total power usage for a particular IC may vary over time. That is, the total power usage for a particular IC may be constantly changing based on external factors. In this description, only one IC 104 is described. Of course, as one of ordinary skill in the art will readily realize, the teachings herein could be applied to systems that include two or more IC's. In such a case, the external power consumption target generator 102 may generate separate consumption targets for one or more of the IC's in the system.

The external power consumption generator 102 is coupled to the IC power control unit 106. The IC power control unit 106 is connected to one or more functional units 108a-108n via a power control bus 107. Each of the functional unit 108 may be uniquely addressed. Thus, and as described above and in greater detail below, the IC power control unit 106 may receive the target power consumption value from the external power consumption generator 102, determine, based on the target consumption value, how much power each functional unit 108 may consume, and communicate the power consumption for each functional unit 108 to each functional unit 108 via the power control bus 107.

The IC 104 may also include a power bus 110. The power bus 110 delivers power to each functional unit 108 as well as the IC power control unit 106. Of course, as one of ordinary skill in the art will readily realize, the IC 104 may include additional power and power control busses. In addition, the IC 104 may include other units for which the power consumption is fixed and, thus, the power consumption for such units may not be controlled by the IC power control unit 106.

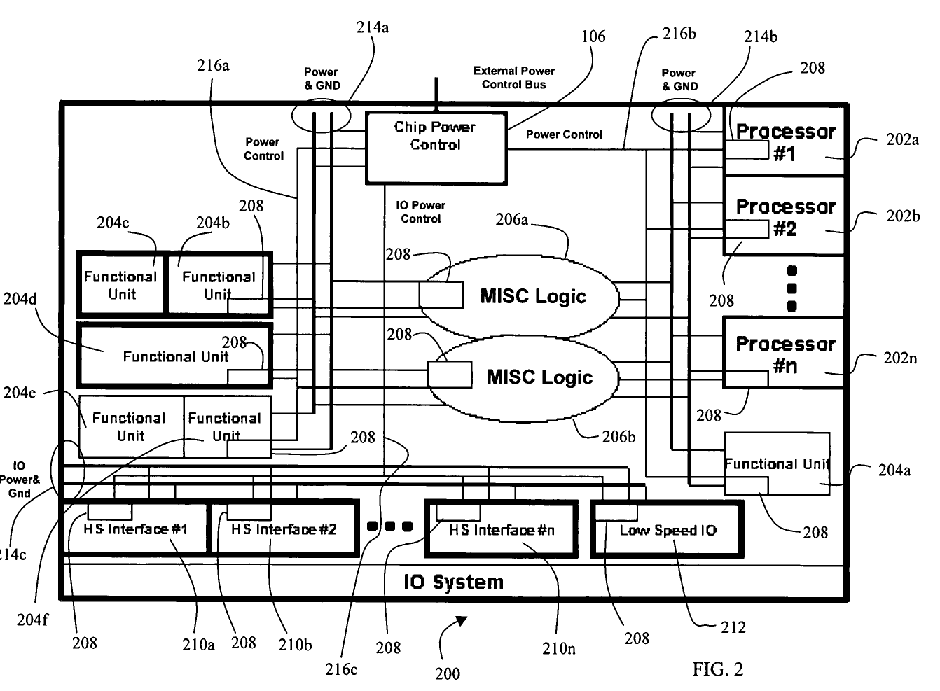

FIG. 2 shows a more detailed block diagram of an integrated circuit 200 according to an embodiment of the present invention. The integrated circuit 200 of this embodiment may include several functional units. For example, the integrated circuit 200 may include functional units designated as embedded processors 202a, 202b and 202n, general functional units 204a, 204b, 204c, 204d, 204e, and 204f, miscellaneous connection logic units 206a and 206b, high-speed input-output interfaces 210a, 210b, and 210n and low speed input-output 212. Of course, the functional units shown in FIG. 2 are by way of example only and any type and number of functional units may be present on an integrated circuit according to embodiments of the present invention.

The integrated circuit may also include one more power grids 214. As shown, the integrated circuit 200 includes first and second power grids 214a and 214b as well as an input-output power grid 214c. Of course, only one power grid is needed and there is no limit to the number of power grids that me be provided. As shown, the first power grid 214a is coupled to general functional units 204b, 204c, 204d, 204e, and 204f, the second power grid 214b is coupled to embedded processors 202a, 202b and 202n and general functional unit 204a, and the input-output power grid 214c is coupled to high-speed input-output interfaces 210a, 210b and 210n and low speed input-output 212. In addition, miscellaneous logic control logic units 206a and 206b are coupled to both the first and second power grids 214a and 214b to illustrate the flexibility of connections between functional units and the power grids 214.

The power grids, as is known in the art, deliver power to functional units to which they are coupled. In the example shown in FIG. 2, the power grids 214 are coupled to each functional unit either directly or indirectly. For instance, the general functional unit 204b is directly coupled to power grid 214a and general functional unit 204c is indirectly coupled to the power grid 214a through general functional unit 204b.

The integrated circuit 200 also includes multiple power control grids 216. The power control grid, according to some embodiments of the present invention connect one or more functional units, either directly or indirectly, to the IC power control unit 106. In some embodiments, the power control grids 216 are formed as a bus structure. A single power control is all that is needed, but, and is shown in FIG. 2, it may be expedient to provide multiple power control grids such as the first power control grid 216a , the second power control grid 216b and the input-output power control grid 216c. In the example shown in FIG. 2, the first power control grid 216a is coupled to general functional units 204b, 204c, 204d, 204e, and 204f, and miscellaneous logic control logic units 206a and 206b, the second power control grid 216b is coupled to embedded processors 202a, 202b and 202n and general functional unit 204a, and the input-output power control grid 216c is coupled to high-speed input-output interfaces 210a, 210b and 210n and low speed input-output 212.

Each component (functional unit) may include unit power level control 208. The unit power level control 208 receives a mode setting from the IC power control unit 106 and causes the particular unit to which it is directly attached or otherwise coupled to operate in mode selected by the IC power control unit 106. Of course, not every element needs such a unit power control but, in the example shown in FIG. 2, all units contain one. In some instances, a particular functional unit may not be capable of operating in more than one mode, thus, it may not include a unit power level control 208.

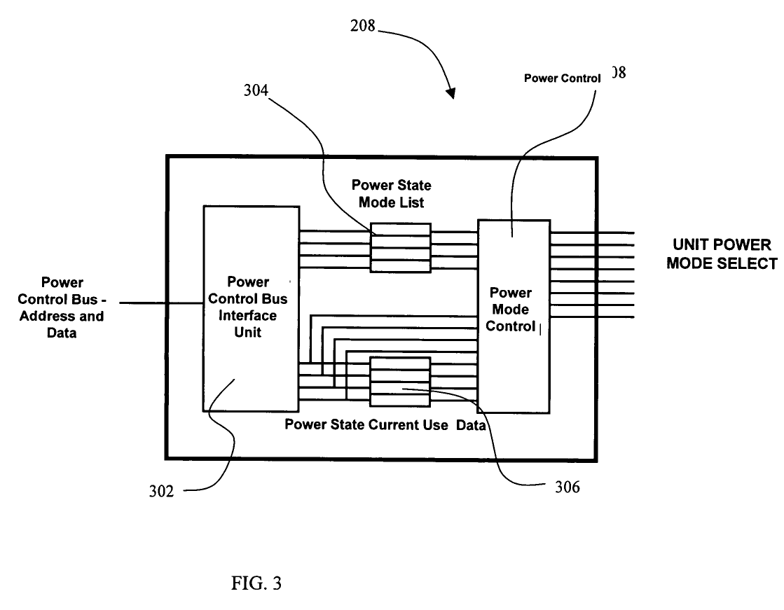

In some embodiments, each functional unit may include one or more unique addresses and memory/registers contained in the unit power level control 208. A more detailed depiction of an example unit power level control 208 is shown in FIG. 3. The example unit power level control 208 includes a power control grid interface unit 302 which configured to facilitate reading data from and writing data to a functional unit to which it is coupled. The power control grid interface unit 302 is coupled to the IC power control unit 106 via the power control grid 216. The unit level power control 208 may also include power state mode list 304 which may, for example, be stored in registers. The power mode state list 304 may also include functional capability and corresponding power dissipation for those power modes.

In some embodiments, the list of power modes and a corresponding set of unit power mode select signal states (created by power mode control module 308) to force the unit into those power mode may be defined during the design phase of the IC as whole. Unit power dissipation corresponding to each power mode can be set in a variety of ways. It may be estimated up front at design time and stored in a read-only memory (ROM) structure. It may be measured at initial chip manufacturing test and stored in an on-chip non-volatile random access memory (NVRAM), or that test data can be sent along with the chip so customers can put it in off-chip NVRAM at system manufacturing time. Optionally, the unit power level control may also include an optional power measuring device 306 that is configured to run at chip power-up, or dynamically during system operation. This data, regardless of how created may be used to determine, for example, by the IC chip control unit 106, the amount of power dissipated in each mode.

In operation, the IC power control unit 106, as discussed above, may be coupled to a system level power allocation bus. Based upon data transferred to the IC power control unit 106 from an external source (the data being the power level dissipation target described above), the IC power control unit 106 programs the power control state of each unit to optimize chip function against a dynamically changing power allocation. For example, a chip running at 60 W is asked to reduce power to 52 W, and 100 ms later, it's told that the power target is now 55 W.

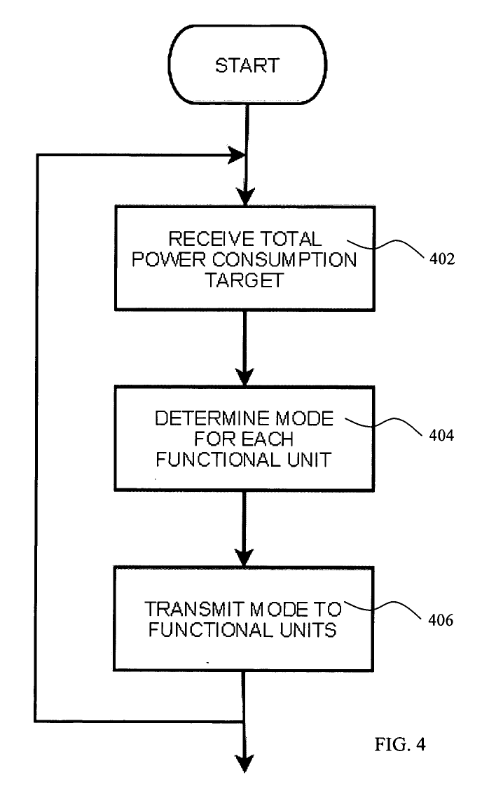

FIG. 4 shows an example of a method according to one embodiment of the present invention. The process begins at block 402 when the IC power control unit receives a total power consumption target. As discussed above, this target may be received from an external source. The process progresses to block 404 where the particular mode for each functional unit is determined. As discussed above, each functional unit may have one or more modes of operation. Each of these modes may have a total power dissipation level.

After determining the mode for each functional unit, the modes of operation are communicated to the functional units at block 406. As discussed above, each function unit may be addressed individually. Of course, as one of ordinary skill in the art will readily realize, in some instances a functional unit may not change modes and, optionally, the mode may not be to be transmitted to that particular functional unit in such instances. After the modes are transmitted to the functional units in block 406 the process returns to block 402 and awaits the receipt of a new total power consumption target. Of course, block 402 could include an optional process (not shown) where the power consumption target is the same as the current power consumption target and, therefore, no action is taken.

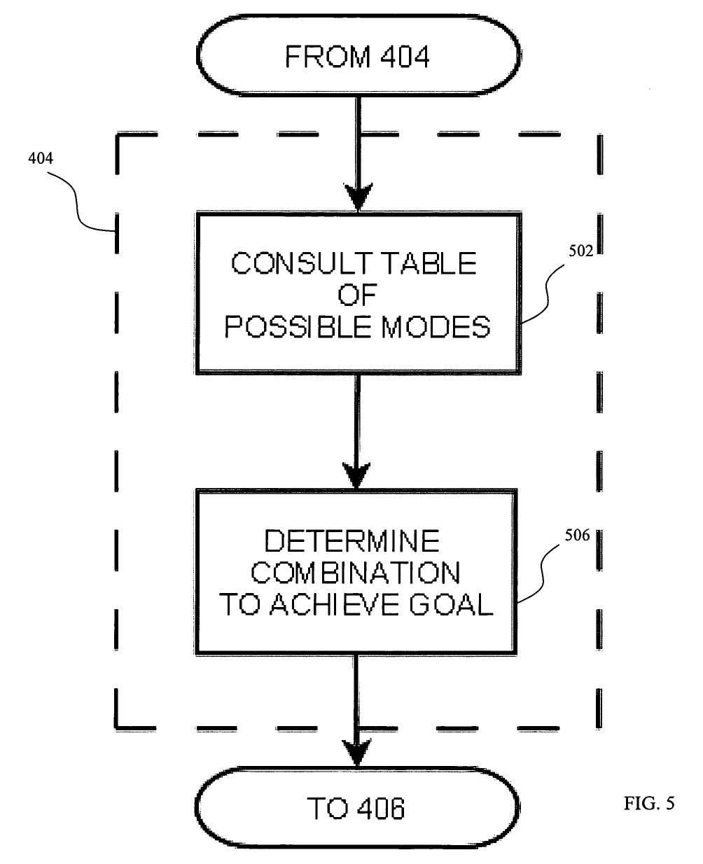

FIG. 5 shows a more detailed flow diagram of the process that may occur in step 404 of FIG. 4. The process begins at block 502 where the table containing the possible modes and possible power dissipation levels is consulted. As described briefly above, this table may be created at the chip design or manufacturing stage. In addition this table may be created or updated every time the IC is powered up by simply cycling each functional unit through all of its modes and recording the power dissipated by each mode.

At step 506 the combination of modes for each of the units may be manipulated in order to achieve the power dissipation goal. One of ordinary skill in the art will readily realize that many methods may be utilized to achieve the process performed in block 506. The process then returns to step 406 of FIG. 4.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A system for dynamic integrated circuit power distribution and control comprising:
an external power consumption target generator configured to generate a power dissipation target for one or more integrated circuits;
a first integrated circuit including:
an IC power control unit coupled to the external power consumption target generator;
a first plurality of functional units, each functional unit of the first plurality including a unit power level control; and
a first power control grid coupling the IC power control unit to one or more of the first plurality of functional units;
wherein the IC power control unit is configured to generate a mode control signal which places at least one of plurality of functional units into a first mode of operation based upon the power consumption target.

2. The system of claim 1 further comprising:
second integrated circuit including:
a second IC power control unit coupled to the external power consumption target generator;
a second plurality of functional units, each functional unit of the second plurality including a unit power level control; and
a second power control grid coupling the IC power control unit to one or more of the plurality of functional units;
wherein the second IC power control unit is configured to generate a mode control signal which places at least one of plurality of functional units into a first mode of operation based upon the power consumption target.

3. The system of claim 1, wherein the IC power control unit includes a table including operating modes for one or more of the first plurality of functional units and a power dissipated by each operating mode.

4. The system of claim 3, wherein the IC power control unit is configured to generate the mode control signal based upon information contained in the table and the power consumption target.

5. The system of claim 3, wherein the table is generated at power on of the system.

6. The system of claim 1, wherein the first integrated circuit further includes:
a second power control grid coupled to the IC power control unit and one or more of the first plurality of functional units.

7. The system of claim 1, wherein the unit power level control includes:
a uniquely addressable receiver configured to allow communication between the IC power control unit and a particular one of the first plurality of functional units.

8. The system of claim 7, wherein the power level control further includes:
a power measuring device configured to determine the power being dissipated at a particular time.

9. An integrated circuit comprising:
an IC power control unit configured to receive a power consumption target value from an external power consumption target generator;
a first plurality of functional units, each functional unit of the first plurality including a unit power level control; and
a first power control grid coupling the IC power control unit to one or more of the first plurality of functional units;
wherein the IC power control unit is configured to generate a mode control signal which places at least one of plurality of functional units into a first mode of operation based upon the power consumption target.

10. The integrated circuit of claim 9, wherein the IC power control unit includes a table including operating modes for one or more of the first plurality of functional units and a power dissipated by each operating mode.

11. The integrated circuit of claim 10, wherein the IC power control unit is configured to generate the mode control signal based upon information contained in the table and the power consumption target.

12. The integrated circuit of claim 10, wherein the table is generated at power on of the system.

13. The integrated circuit of claim 9, wherein the first integrated circuit further includes:
a second power control grid coupled to the IC power control unit and one or more of the first plurality of functional units.

14. The integrated circuit of claim 9, wherein the unit power level control includes:
a uniquely addressable receiver configured to allow communication between the IC power control unit and a particular one of the first plurality of functional units.

15. The integrated circuit of claim 14, wherein the power level control further includes:
a power measuring device configured to determine the power being dissipated at a particular time.

16. The integrated circuit of claim 14, wherein the power level control further includes:
a power mode control module configured to create power mode select signals for placing the functional unit a particular state.

17. A method for dynamically controlling power distribution of a power in system including multiple integrated circuits:
receiving at a first integrated circuit a power consumption target from an power consumption target generator;
selecting a mode of operation for one or more functional units of the first integrated circuit based on the power consumption target; and
transmitting the mode of operation to one or more of the functional units.

18. The method of claim 16, wherein selecting includes accessing a table containing possible operation modes for one or more of the functional units.

19. The method of claim 17, wherein the table is created at power on.

20. The method of claim 17, wherein the table includes a power dissipation related to each mode.
